(19) United States
(12) Patent Application Publication
(10) Pub. No.: US 2013/0015636 A1
(43) Pub. Date: Jan. 17, 2013

(54) Collapsible trailer for compact parking

(71) Applicants: Daniel Robert Shepard, North Hampton, NH (US); Britta Shepard, North Hampton, NH (US)

(72) Inventors: Daniel Robert Shepard, North Hampton, NH (US); Britta Shepard, North Hampton, NH (US)

(21) Appl. No.: 13/507,574

(22) Filed: Jul. 11, 2012

Related U.S. Application Data
(60) Provisional application No. 61/572,109, filed on Jul. 11, 2011.

(51) Int. Cl. B62D 63/06

(52) U.S. Cl. 280/415.1

(57) ABSTRACT

The present invention is a foldable trailer that drops close to the ground and shortens in length when folded such that it can be parked below the vehicle that towed it. In this way, the trailer and vehicle can both be parked in the same, single space. During towing, the trailer is locked into its opened towing position and the weight of the device being towed helps to maintain the opened position. The trailer can be folded into its closed parking position while still hitched to the vehicle by which it was towed to facilitate moving it into its parking space before being unhitched. Once unhitched, the trailer will be parallel to and close to the ground such that the vehicle can then park above it. By sharing the same place, parking fees are reduced and preparation time (time spent in parking arrangements) is shortened.

### CROSS REFERENCE TO RELATED APPLICATIONS

The present disclosure claims priority to Provisional Patent Application 61/572,109 filed on Jul. 11, 2011 by Shepard, et. al titled “COLLAPSIBLE TRAILER FOR COMPACT PARKING” and that application is hereby incorporated herein in its entirety.

### REFERENCE REGARDING FEDERAL SPONSORSHIP

Not Applicable

### STATEMENT REGARDING FEDERALLY SPONSORED RESEARCH OR DEVELOPMENT

Not Applicable.

### FIELD OF THE INVENTION

The present invention relates to trailers, and more particularly to trailers that can be collapsed and stored beneath the vehicle by which it is towed.

### SUMMARY OF THE INVENTION

Many people are familiar with trailers for hauling a boat, jet ski, snowmobile, or the like. As populations grow of people who utilize trailers for recreational motorized activities, the parking facilities are becoming more crowded. Often, the land on which a car and trailer might be parked is expensive land; when boating, the preferred location to park one's car and trailer while boating would typically be waterfront or water-view property. As such, such parking is limited and is often restricted against one person occupying two spaces (one for his car and another for his boat). As a result, such lots often prohibit trailer parking, opting instead for a remotely located lot for trailer parking. These arrangements require that the boat owner, after launching their boat, drive the empty trailer to the remote lot for drop-off and then return with just the car to park at the close-by lot. Often, the remote lot will charge a fee for parking the trailer and, in some cases, both the remote lot and the close-by lot charge a parking fee.

Prior art reveals several attempts to address the problems associated with trailer storage. The simplest solutions address parts of the problem ranging from ways of folding up the trailer such that it takes up much less space (see: Lovendahl, U.S. Pat. No. 3,989,264 titled “ARTICULATED BOAT TRAILERS” but this solution is limited to small trailers) or trailers that fold accordion style (see: Jolly, U.S. Pat. No. 6,902,179 titled “COLLAPSIBLE BOAT TRAILER SYSTEM” but, while this solution works for large trailers, it still takes up significant space and would not enable vehicle and trailer to fit within a single parking space). While these solutions are helpful, they only each address a part of the trailer parking problem.

The present invention solves the shortcomings of foldable trailer systems that still fill up a second or part of a second parking space. The present invention is a foldable trailer that drops close to the ground when it is folded such that it can be parked beneath the vehicle that towed it. In this way the trailer and vehicle by which that trailer was towed can both be parked in the same, single space. In operation the trailer can be locked into its opened position and the weight of the boat (or other motorized sporting device) being towed will also help to maintain the opened position. When being parked, the trailer folds in such a way that it drops close to the ground and shortens in length. The trailer can be folded into its parking position while still hitched to the vehicle by which it was towed to facilitate moving it into its parking space before unhitching the trailer. Once unhitched, the trailer will be parallel to and close to the ground such that the vehicle can then park above it. Larger trailers built according to the present invention will necessarily be tower by a larger vehicle with higher ground clearance and as such the present invention can be scaled up. By sharing the same parking space, parking fees are reduced and preparation time (time spent in parking arrangements) is shortened.

### BRIEF DESCRIPTION OF THE DRAWINGS

FIG. 1 illustrates a side-view of a trailer according to the present invention in trailering position.

FIG. 2 illustrates a side-view of a trailer according to the present invention in folded position.

FIG. 3 illustrates a side-view of a variation of a trailer according to the present invention in trailering position and incorporating suspension.

### DESCRIPTION OF THE PREFERRED EMBODIMENT

The present invention is a foldable trailer that drops close to the ground when it is folded such that it can be parked below the vehicle that towed it. In this way the trailer and vehicle by which that trailer was towed can both be parked in the same, single space. In operation the trailer can be locked into its opened position and the weight of the boat (or canoe, kayak, bicycle, jet ski or any other motorized sporting device or any device to be towed) being towed will also help to maintain the opened position. When being parked, the trailer folds in such a way that it drops close to the ground and shortens in length. The trailer can be folded into its parking position while still hitched to the vehicle by which it was towed to facilitate moving it into its parking space before unhitching the trailer. Once unhitched, the trailer will be generally parallel to and close to the ground such that the vehicle can then park above it. By sharing the same parking space, parking fees are reduced and preparation time (time spent in parking arrangements) is shortened.

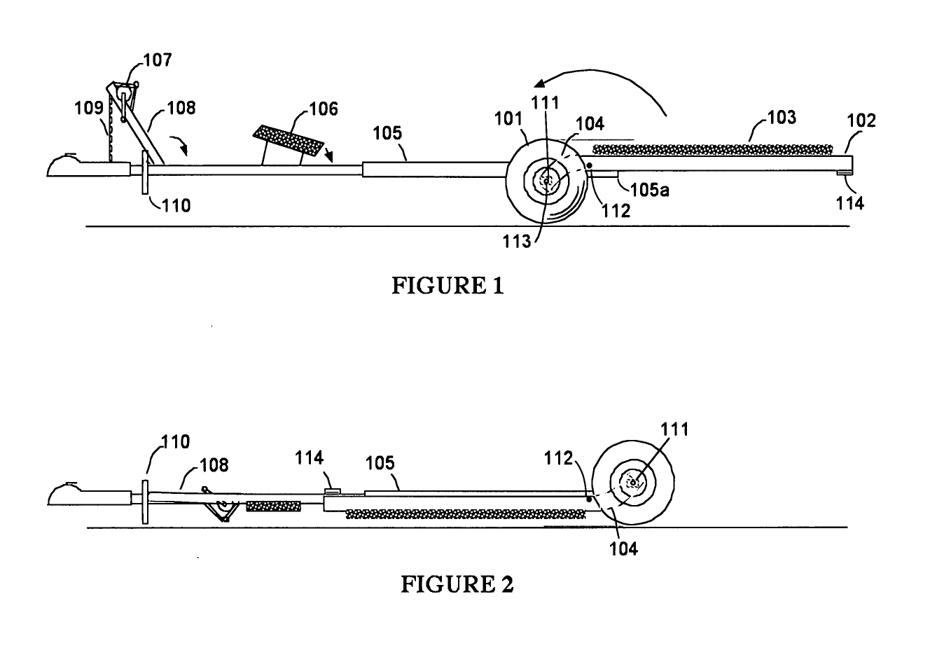

Refer now to the figures, which show a preferred embodiment of the invention. FIG. 1 shows a trailer according to the present invention. In this figure, a trailer having wheels 101 at the bottom of foldable boat support rails 102 on which boat hull supports 103 are mounted. Of particular importance are curved rail ends 104 behind wheels 101. These curved rails cause wheels 101 to be positioned below the body of the trailer 105 while in towing position. Additional boat bow supports 106 are on hinged arms that fold up and out into position. A winch 107 to draw a boat onto the trailer is supported by a winch support arm 108 that is held in position by chain 109 to prevent its folding when a boat is being winched or towed. An optional snap pin holds boat bow supports 106 and boat hull supports 103 in position while a boat is being loaded or launched so that a wave or motion of the trailer does not inadvertently cause either boat bow supports 106 or boat hull supports 103 to move from the opened position. However, it is the weight of the boat that primarily keeps both the boat bow supports 106 and boat hull supports 103 in position while trailering. Also, in the opened position, boat support rails 102 and boat bow supports 106 will rest against the body of the trailer 105 or against brackets that are part of the body of the trailer 105 for better support and these brackets can include a clip or a snap pin to prevent the supports from unintentionally folding away from their opened or closed positions. Also, cross bar 111 through which axel 113 is found has the dual purpose of preventing the curved rail ends 104 from spreading and to provide a bracing mechanism against the body of the trailer 105 so as to brace against the upward force of the wheels 101; this significantly reduces the force on the pivot point 112. An additional cross brace (not shown) between the boat support rails 102 will rest on top of the back end of the body of the trailer 105a when in the opened position to further reduce the force on the pivot point 112. It should be noted that the pivot point 112 and axel 113 are positioned so that axel 113 will clear the back end of the body of the trailer 105a during folding. That is to say, the distance from pivot point 112 to the axel 113 is greater than the distance from pivot point 112 to the back end of the body of the trailer 105a. It is also important that the end of curved rail ends 104 are entirely behind wheel 101 such that as the back end of the trailer is being folded, the curved rail ends 104 do not scrape into the ground.

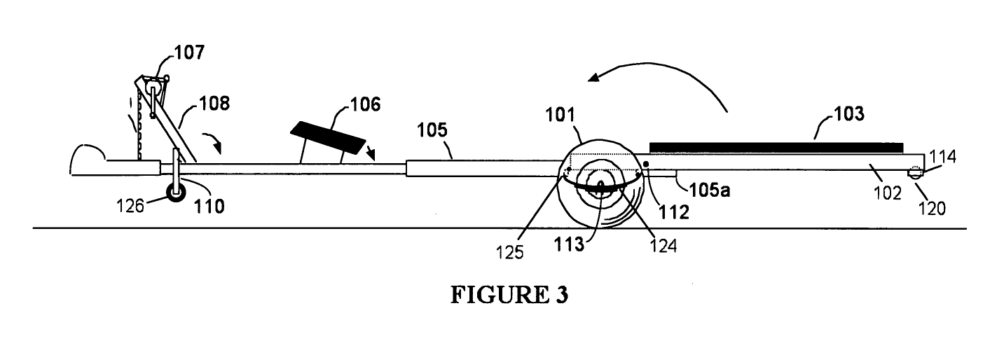

To park the trailer, the tow vehicle will back the trailer into the parking spot after removing snap pins and folding boat support rails 102 into their closed position as shown in FIG. 2. It should be noted that due to the curved rail ends 104 the tires are now positioned with the center of the wheels above the center line of the trailer, thereby lowering the frame of the trailer close to the ground. Generally speaking, the frame will now be lower than the axel 113. Also, boat bow supports 106 are folded towards the center of the trailer and down and chain 109 is detached and winch support arm 108 is folded back and down. Once the components are folded into their closed positions, the trailer is backed into the parking space such that the wheels 101 are positioned at the back of the space. The trailer is then unhitched from the vehicle and the tongue and coupler end are lowered to the ground and supported by stand 110. The trailer is now in its lowest position relative to the ground and the tow vehicle can be backed into the space above the trailer such that, at most, only the wheels are not covered. Alternatively, as shown in FIG. 3, a small caster wheel 126 (to support the front end of the closed trailer) can be added to the bottom of stand 110 such that the trailer can be detached from the vehicle and maneuvered into the space by hand (wheels end last if the vehicle is first parked in the space or wheel end first if the vehicle is to be parked in the space after positioning the trailer in the space). This wheel can be fixed to facilitate straight-in positioning or steerable or can have a locking mechanism to make a steerable wheel be fixed. Again, in the closed position, boat support rails 102 and boat bow supports 106 rest against brackets that are part of the body of the trailer 105 for better support. These supports also include cross bar 114 which has the dual purpose of preventing the folding boat support rails 102 from spreading and to provide a bracing mechanism against the body of the trailer 105 so as to provide a stop when in the closed position; this also significantly reduces the force on the pivot point 112. A handle 120 can be provided in the center of cross bar 114 so as to enable the operator to fold the folding boat support rails 102 into or out of the folded frame position, as shown in FIG. 3.

Boat supports 103 and 106 are often covered with a material such as a shag carpet to prevent scraping damage to the boat's hull. Other support mechanisms can be employed as well such as rollers and rocker arms and one skilled in the art will easily see how to include them in light of the present teaching. Also, for larger trailers, the winch can be adapted to perform the component folding actions so that the operator does not have to fold up the heavy components by hand.

A variation on the present invention is depicted in FIG. 3. This variation adds suspension to the trailer that will reduce the bouncing and impact and potential damage (e.g., impact damage) to a boat being towed on the trailer as well as better keep the wheels in contact with the road while towing. In this variation, curved rail ends 104 are replaced by having folding boat support rails 102 be straight and spring suspension 124 is added. In this way, the axel 113 is still offset below the center line of folding boat support rails 102 by suspension 124 so that when the back end of the trailer is flipped into its folded position, the trailer will once again be positioned close to the ground and hanging below axel 113 and supported by suspension 124. In implementing this variation, it is important that the front end mount 125 of spring suspension 124 (as well as the adjacent end of folding boat support rails 102) is entirely behind wheel 101 such that as the back end of the trailer is being folded, the front end mount 125 does not scrape into the ground.

The foregoing description of an example of the preferred embodiment of the invention and the variations thereon have been presented for the purposes of illustration and description. It is not intended to be exhaustive or to limit the invention to the precise forms disclosed. Many modifications and variations are possible in light of the above teaching. It is intended that the scope of the invention be limited not by this detailed description, but rather by any claims appended hereto.

I claim:

1. A trailer comprising means to fold the frame of the trailer into a position whereby the frame of the trailer is made to come close enough to the ground that the trailer can be positioned in a parking space and a towing vehicle can be positioned in the same parking space above the trailer.

2. A trailer comprising means to fold the trailer such that the frame is lowered to a position that is generally below the wheel axel.

3. A method for parking a trailer and a towing vehicle comprising the steps of:
i. repositioning components of the trailer such that the trailer is generally positioned closer to the ground than when it is when in use for towing,
ii. positioning the trailer in an area for parking, and
iii. parking the tow vehicle in said parking area, such that the tow vehicle and the trailer generally occupy the same area for parking.

4. The trailer of claim 1 further comprising means to fold one or more supports to fit under the tow vehicle when parked.

5. The trailer of claim 1 further comprising means to fold the back end of the frame such that the length of the trailer when folded is less than when it is in the towing position.

6. The trailer of claim 1 further comprising a handle to assist in the folding of one or more of the trailer components.

7. The trailer of claim 1 further comprising a winch means to assist in the folding of one or more of the trailer components.

8. The trailer of claim 1 further comprising suspension to reduce impacts to a device being towed on the trailer or to keep the trailer wheels in better contact with the road.

9. The trailer of claim 1 where the device being towed is one of a boat, a canoe, a kayak, a bicycle, a jet ski, a motorized sporting device, or any device to be towed.

10. The trailer of claim 1 further comprising a wheel to support the front end of the trailer to facilitate positioning of the trailer.

11. The wheel of claim 10 whereby the wheel is either fixed or steerable.

12. The trailer of claim 2 further comprising means to fold one or more supports to fit under the tow vehicle when parked.

13. The trailer of claim 2 further comprising means to fold the back end of the frame such that the length of the trailer when folded is less than when it is in the towing position.

14. The trailer of claim 2 further comprising a handle to assist in the folding of one or more of the trailer components.

15. The trailer of claim 2 further comprising a winch means to assist in the folding of one or more of the trailer components.

16. The trailer of claim 2 further comprising suspension to reduce impacts to a device being towed on the trailer or to keep the trailer wheels in better contact with the road.

17. The trailer of claim 2 where the device being towed is one of a boat, a canoe, a kayak, a bicycle, a jet ski, a motorized sporting device, or any device to be towed.

18. The trailer of claim 2 further comprising a wheel to support the front end of the trailer to facilitate positioning of the trailer.

19. The method of claim 3 whereby the trailer is positioned before the tow vehicle is parked.

20. The method of claim 3 whereby the tow vehicle is parked before the trailer is positioned.
